(19) United States
(12) Patent Application Publication
(10) Pub. No.: US 2026/0353078 A1
(43) Pub. Date: Nov. 5, 2026

(54) SAFEGUARDING AUTOMATIC DEPENDENT SURVEILLANCE BROADCAST COMMUNICATION

(71) Applicant: Honeywell International Inc., Charlotte, NC (US)

(72) Inventors: Kantha Chikkegowda, Bangalore (IN); Kalimulla Khan, Bangalore (IN); Subhransu Sahoo, Bengaluru (IN); Ramesh Shetty, Bangalore (IN)

(21) Appl. No.: 19/549,552

(22) Filed: Feb. 25, 2026

(30) Foreign Application Priority Data
Apr. 30, 2025 (IN) 202511041736

(51) Int. Cl. H04W 12/06; H04W 4/029; H04W 12/0431; H04W 84/06

(52) U.S. Cl. CPC H04W 12/06; H04W 4/029; H04W 12/0431; H04W 84/06

(57) ABSTRACT

Certain aspects of the disclosure provide security for automatic dependent surveillance-broadcast (ADS-B) data communications. An authenticator can verify the sender of ADS-B data, distinguishing legitimate from malicious actors and enabling a receiver to trust or discard the data. The authenticator can use a multifactor approach to verify a sender's identity, including cryptography, trusted third parties, and data analysis. A cryptographic challenge-response can be performed by generating and encrypting a random number with the public key of the sender and verifying the decrypted random number with the private key. The authenticator can also obtain and validate a digital certificate issued by a trusted party and evaluate the ADS-B data against flight mission parameters.

### CROSS-REFERENCE TO RELATED APPLICATIONS

This application claims priority to and the benefit of Indian Provisional Patent Application No. 202511041736, filed Apr. 30, 2025, the entire contents of which are incorporated herein by reference.

### TECHNICAL FIELD

Aspects of the subject disclosure relate to aviation surveillance, and more specifically, automatic dependent surveillance-broadcast communication.

### BACKGROUND

Automatic Dependent Surveillance-Broadcast (ADS-B) has become a cornerstone of modern aviation, revolutionizing air traffic management (ATM) through its ability to transmit real-time flight data, including satellite-derived position, altitude, and velocity. Since the widespread adoption of ADS-B over the past decade, ADS-B has significantly enhanced situational awareness, improved safety, extended surveillance coverage into previously unmonitored airspace, and enabled more efficient routing and separation.

### SUMMARY

The following summary provides a basic understanding of some aspects of the disclosed subject matter. This summary is not an extensive overview. It is not intended to identify key elements or to delineate the scope of the claimed subject matter. Its sole purpose is to present some concepts in a simplified form as a prelude to the more detailed description presented later.

Briefly described, various aspects of this disclosure pertain to providing security for automatic dependent surveillance broadcast (ADS-B) communication. ADS-B enhances air traffic management (ATM) by enabling real-time transmission of flight data, including global navigation satellite system (GNSS) coordinates and altitude information from aircraft. However, despite its many advantages, the fundamental design of ADS-B introduces notable security vulnerabilities and is susceptible to malicious threats, including the broadcast of fraudulent ADS-B signals. The current data format of ADS-B emphasizes simplicity for diverse users, including Air Traffic Control (ATC), ground stations, flight crews, and aviation tracking services. However, as ADS-B may be used for tactical decision-making, robust security measures become desirable to protect against potential breaches that could affect flight safety. Techniques of this disclosure provide a balanced approach that enhance security while maintaining the operational utility of ADS-B data. While heightened security may be prioritized for safety-sensitive flight operations, general access for non-sensitive applications can be provisioned with fewer protocol restrictions, allowing various stakeholders to utilize the information while maintaining operational safety.

More particularly, an authenticator is disclosed that can verify the sender of ADS-B data, distinguishing legitimate from malicious actors and enabling a receiver to trust or discard the data. The authenticator can use a multifactor approach to verify a sender's identity, including cryptography, trusted third parties, and data analysis. A cryptographic challenge-response can be performed by generating and encrypting a random value with the public key of the sender and verifying the decrypted random value with the private key. The authenticator can also obtain and validate a digital certificate issued by a trusted party and evaluate the ADS-B data against flight mission parameters and known attack patterns, among other contextual data.

Certain aspects provide a computer-implemented method for authenticating automatic dependent surveillance-broadcast (ADS-B) data, comprising receiving a request to authenticate the ADS-B data, generating a random value, encrypting the random value with a public key associated with an aircraft to produce an encrypted random value, sending a challenge message to the aircraft with the encrypted random value, receiving a decrypted random value in response to the challenge message, performing a comparison of the decrypted random value to the random value, in response to the comparison indicating a challenge match, determining the ADS-B data as being sent by an authenticated sender, in response to the comparison indicating a challenge mismatch determining the ADS-B data as being sent by an unauthenticated sender, and returning an indication of authenticated or unauthenticated in response to the request based on determining the ADS-B data as being sent by an authenticated sender or an unauthenticated sender.

Other aspects provide processing systems configured to perform the aforementioned method as well as those described herein; non-transitory, computer-readable media comprising instructions that, when executed by a processors of a processing system, cause the processing system to perform the aforementioned method as well as those described herein; a computer program product embodied on a computer readable storage medium comprising code for performing the aforementioned method as well as those further described herein; and a processing system comprising means for performing the aforementioned method as well as those further described herein.

To accomplish the foregoing and related ends, certain illustrative aspects of the claimed subject matter are described herein in connection with the following description and annexed drawings. These aspects are indicative of several ways in which the subject matter may be practiced, all of which are intended to be within the scope of the claimed subject matter. Other advantages and features may become apparent from the following detailed description when considered in conjunction with the drawings.

### DESCRIPTION OF THE DRAWINGS

The appended figures depict certain aspects and are therefore not to be considered limiting of the scope of this disclosure.

FIG. 1 is a block diagram showing an overview of an example computing environment in which techniques of the subject disclosure may be implemented.

FIG. 2 depicts an example system block diagram of an implementation of a security mechanism for ADS-B communication.

FIG. 3 depicts an example secure ADS-B broadcast between two aircraft and a secure cloud service.

FIG. 4 depicts an example spoofing attempt within an ADS-B communication system involving two aircraft and a secure cloud service.

FIG. 5 illustrates an example secure ADS-B broadcast between two aircraft and a secure cloud service.

FIG. 6 depicts an example spoofing attempt within an ADS-B communication system involving two aircraft and a secure cloud service.

FIG. 7 is a flowchart diagram illustrating an example method of ADS-B data authentication.

FIG. 8 is a flowchart diagram depicting an example method of ADS-B data interaction.

FIG. 9 shows an example of a gateway device for facilitating communication between an avionics system and a computing device for executing EFB applications in accordance with techniques of this disclosure.

FIG. 10 shows an example of a computing device for executing EFB applications in accordance with techniques of this disclosure.

FIG. 11 shows an example of an avionics system in accordance with techniques of this disclosure.

FIG. 12 is a block diagram illustrating an example of a ground-based computing system in accordance with techniques of this disclosure.

To facilitate understanding, identical or similar reference numerals have been used, where possible, to designate elements that are common to the drawings. It is contemplated that elements and features of one embodiment may be beneficially incorporated in other embodiments without further recitation.

### DETAILED DESCRIPTION

Aspects of the subject disclosure provide apparatuses, methods, processing systems, and computer-readable mediums for safeguarding automatic dependent surveillance broadcast (ASD-B) communication.

As aviation continues to evolve, the adoption of ADS-B is positioned as a cornerstone of next-generation air traffic systems worldwide, potentially replacing or supplementing radar technology with more precise and responsive capabilities. However, the implementation of ADS-B is not without challenges. The system's fundamental design, which prioritizes accessibility and ease of use for diverse stakeholders, including air traffic control (ATC) and flight crews, as well as civilian flight-tracking services, may also introduce security vulnerabilities. Unlike traditional radar systems that operate in a controlled environment, ADS-B relies on unencrypted broadcasts, making ADS-B communication susceptible to various forms of cyberattacks. For example, a malicious actor may manipulate ADS-B signals to create false representations of aircraft locations, potentially leading to dangerous situations in the airspace.

Various incidents have underscored these risks, including reports of unauthorized ADS-B transmissions that trigger false alarms and distract pilots during critical phases of flight. Such events highlight the need for robust security measures to protect aviation data. While safeguarding the mechanisms that power ADS-B broadcasts is advantageous, it is also desirable to strike a balance that ensures continued access for diverse legitimate users, such as pilots and ATC, while preventing abuse by malicious actors.

Aspects of this disclosure address security challenges associated with ADS-B communication without compromising the operational efficiency and effectiveness of the communication system. A robust authentication mechanism is provided that operates in real-time or near-real-time to mitigate risks associated with data spoofing and unauthorized transmissions and to enhance safety in air traffic management. In accordance with one aspect, an ADS-B authenticator can be implemented as a secure, network-accessible service configured to perform multi-factor authentication to distinguish between legitimate and malicious entities. In one instance, a cryptographic challenge-response can be employed to verify sender identity. Further, a digital certificate issued by a trusted authority can be validated to verify that the public key is bound to a particular entity. Furthermore, contextual analysis can be utilized to identify anomalous data patterns to detect potentially compromised senders. In this manner, even if a malicious entity steals a private key and digital certificate, authentication can fail due to anomalous data, such as an aircraft's location shifting by 100 miles between ADS-B broadcasts. Furthermore, the ADS-B authenticator can operate in conjunction with traditional ADS-B mechanisms and allow users to select a security level that meets their operational needs.

Aspects of the subject disclosure provide a technical improvement to the functioning of aviation communication networks and onboard flight management systems. More particularly, aspects of the disclosure resolve the inherent vulnerability of unencrypted ADS-B broadcasts by introducing an authenticator. The authenticator can be a cloud-based service that provides a multi-layered approach to authentication, combining a cryptographic challenge-and-response, digital certificate verification, and contextual analysis of flight mission parameters and historical threat data. The authenticator transforms raw, unverified radio signals into legitimate, trusted data. Consequently, the authenticator improves the operation of receiving aircraft avionics by actively filtering spurious data packets, preventing erroneous collision-avoidance maneuvers, and enhancing the overall physical safety and processing efficiency of aircraft navigation systems.

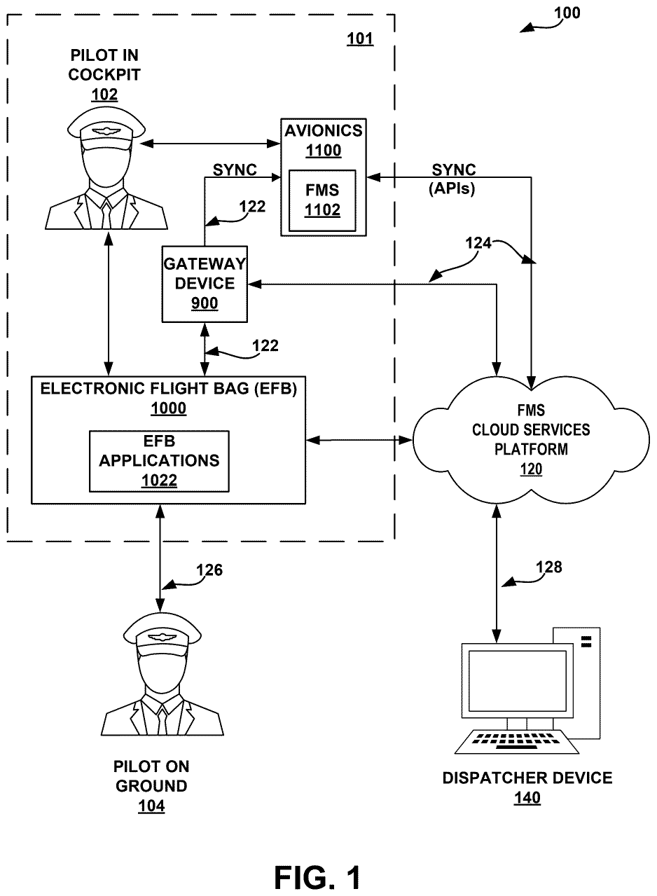

FIG. 1 shows an overview of an example computing environment 100, according to one or more examples of the subject disclosure regarding safeguarding communication. In computing environment 100, gateway device 900 is configured to facilitate communication between EFB (Electronic Flight Bag) 1000 and avionics 1100. Gateway device 900, EFB 1000, and avionics 1100 are all devices or systems that may be located inside aircraft 101. Computing environment 100 also includes a connected FMS cloud services platform 120 (platform 120) and a dispatcher device 140, which may be located outside of aircraft 101.

EFB 1000 may be a computer device carried by a pilot or a flight crew, which may store, for example, navigational charts, maps for air and ground operations of an aircraft, a flight plan management system, an aircraft operating manual, flight-crew operating manual, software applications which automate flight-related or avionics-related computation tasks, and/or any application or data which may be installed in a general purpose computing platform. EFB 1000 may include a pilot information display (PID).

Avionics 1100 generally represents any electronic system that may be implemented in an aircraft. Avionics 1100 may, for example, perform functions related to communication, navigation, safety monitoring, and other such functionalities. Avionic 1100 may include a plurality of modular components or subsystems, e.g., line replaceable units (LRUs), that are configured to be connected and disconnected via standard interfaces and configured to be swappable in order to reduce aircraft downtime due to maintenance. LRUs are generally designed to be replaceable in the field or at an operating station (e.g., a hanger) that is otherwise remote from a manufacturing facility, a maintenance depot, or other maintenance location. Avionics 1100 may also include other subsystems that are not LRUs.

Avionics 1100 includes FMS 1102, which represents a specialized computer system with specialized software configured to automate in-flight tasks according to a flight plan. In this regard, FMS 1102 may be considered to be a full or partial autopilot system. FMS 1102 may, for example, perform real-time monitoring of the aircraft's position using onboard sensors (like GPS) and compare the position to the planned route defined in the flight plan. FMS 1102 may also perform automatic corrections if the aircraft deviates from the planned path by adjusting the course of the aircraft to bring the aircraft back to the path defined in the flight plan.

Gateway device 900, also referred to as an avionics hub or aircraft data gateway, acts as a communication gateway and connects, manages, and distributes data between various electronic systems onboard aircraft 101. Gateway device 900 may, for example, facilitate wired or wireless communication between various LRUs of avionics 1100 by performing data routing and data conversion. Gateway device 900 may also facilitate wired or wireless communication between non-avionics-integrated computing devices, such as EFB 1000, FMS cloud services platform 120, and the like. Gateway device 900 may also implement various security features to verify the accuracy and integrity of data being communicated to, or within, avionics 1100.

Dispatcher device 140 may be any computer device that may be accessed by a user who performs planning, flying, navigating, or managing tasks associated with aircraft, airspaces, airports, or flight plans. Accordingly, the user is not limited to a dispatcher, and the dispatcher device 140 is not limited to a device of a dispatcher. The connected FMS cloud services platform 120 may be a cloud-based platform that provides FMS services to any user who has authorized access to the platform.

As shown in FIG. 1, the environment 100 may accommodate access by various types of users. For example, a pilot 102, who may be in cockpit, may have access to EFB 1000 and EFB applications 1022 installed on EFB 1000. Pilot 102 may also have access to avionics 1100 and FMS 1102, through which pilot 102 may access the connected FMS cloud services platform 120. EFB applications 1022 may access connected FMS cloud services platform 120 and provide the FMS services to the users of EFB 1000 in which the EFB applications 1022 are installed. In that way, EFB 1000 may provide pilot 102 user-friendly and customized user interfaces, by which pilot 102 may interact with FMS services from the platform 120.

FMS 1102 may also be configured to synchronize data 124 with connected FMS cloud services platform 120, using, for example, an application programming interface (API). In other examples, FMS 1102 may be configured to synchronize data 124 with connected FMS cloud services platform 120 through gateway device 900. In addition, FMS 1102 may also be configured to synchronize data 122 with EFB applications 1022 via gateway device 900. Thus, in some implementations, FMS 1102 may be synchronized with data from both EFB 1000 and platform 120 in real-time or at predetermined intervals, in such a way that the pilot 102 may rely on the on-board FMS 1102 for tasks arising in computing environment 100. The data being synchronized may, for example, be flight data, although the techniques of this disclosure are not necessarily limited to flight data.

A pilot 104, who may be on ground, may also access EFB 1000 and the EFB applications 1022. In some implementations, the pilot 104 and the pilot 102 in the cockpit may be the same pilot, yet under different circumstances (e.g., time and location of the access). Additionally, or alternatively, the pilot 104 may be a different pilot, or another authorized member of the flight crew, who accesses EFB 1000 on the ground for an official duty related to the connected FMS cloud services platform 120. While pilot 104 is accessing the EFB applications 1022 via EFB 1000, the EFB applications 1022 may access the connected FMS cloud services platform 120 to receive various FMS services. In that way, EFB 1000 may provide user-friendly and customized user interfaces, by which FMS services 126 from the connected FMS cloud services platform 120 may be serviced to pilot 104.

A dispatcher or other user may also access the connected FMS cloud services platform 120 through a dispatcher device 140. A dispatcher, in accordance with the present disclosure, may be any authorized personnel performing duties related to dispatching of aircraft in computing environment 100. For example, a dispatcher may be an airline staff, an airport staff, air traffic control personnel, a ground control personnel, a member of a relevant aviation authority, or any other authorized person who may benefit from FMS services from the connected FMS cloud services platform 120 in performing their duties. Dispatcher device 140 may be any computing device capable of establishing a connection 128 to the cloud and interfacing with the connected FMS cloud services platform 120. While the dispatcher is accessing the FMS services via the dispatcher device 140, the dispatcher device 140 may access the connected FMS cloud services platform 120 to receive various FMS services. In that way, the dispatcher device 140 may provide user-friendly and customized user interfaces, by which FMS services from the connected FMS cloud services platform 120 may be serviced to the dispatcher.

FMS 1102, EFB 1000, and dispatcher device 140 may include one or more devices capable of receiving, generating, storing, processing, and/or providing information associated with FMS services. For example, FMS 1102, EFB 1000, or the dispatcher device 140 may include a communication and/or computing device, such as a mobile phone (e.g., a smart phone, a radiotelephone, etc.), a computer (e.g., a desktop computer, a laptop computer, a tablet computer, a handheld computer), a gaming device, a wearable communication device (e.g., a smart wristwatch, a pair of smart eyeglasses, etc.), or a similar type of device.

As part of facilitating communication between any of avionics 1100, EFB 1000, or FMS cloud services platform 120, the systems and devices may be configured to transmit and receive flight plans in the form of a .RTE (route) file, a .FPL file (flight plan), or other file formats. Gateway device 900 and avionics 1100 may be configured to transmit and receive .RTE and .FPL files using the encryption-based process described in this disclosure.

A .RTE file is a standard file format that may be used by FMS 1102 and EFB applications 1022 to store and exchange flight planning data. A .RTE file includes some or all of sections for flight information, route details, altitude and speed information, fuel information, performance data, weather information, and other notes or remarks of interest to a pilot or other user. Each section then includes a field name and a value for the field name. A non-exhaustive list of fields that may be included in a .RTE file are FLIGHT_NUMBER, AIRCRAFT_TYPE, DEPARTURE_AIRPORT, DESTINATION_AIRPORT, ESTIMATED_DEPARTURE_TIME, ESTIMATED_ARRIVAL_TIME, WAYPOINTS, AIRWAYS, DEPARTURE_PROCEDURE, ARRIVAL_PROCEDURE, CRUISING_ALTITUDE, CLIMB_PROFILE, DESCENT_PROFILE, TOTAL_FUEL, TRIP_FUEL, RESERVE_FUEL, TAKEOFF_WEIGHT, LANDING_WEIGHT, ZERO_FUEL_WEIGHT, DEPARTURE_WEATHER, ARRIVAL_WEATHER, ENROUTE_WEATHER, PILOT_REMARKS, OPERATIONAL_NOTES.

One or more pilots (e.g., pilots 102 and 104) and dispatcher (e.g., a user of dispatch device 140) may use . RTE files to plan and file flight routes and ensure compliance with air traffic control and safety regulations. A . RTE file may be uploaded from EFB 1000 to FMS 1102 to provide necessary flight details for navigation and management during the flight. The interoperability of . RTE files may facilitate sharing of flight plans between different systems and stakeholders (e.g., airlines, airports, air traffic control). Instead of or in addition to .RTE files, FMS 1102 and EFB applications 1022 may exchange .FPL files, which include similar information as .RTE files and are used for similar purposes as .RTE files but have a different formatting.

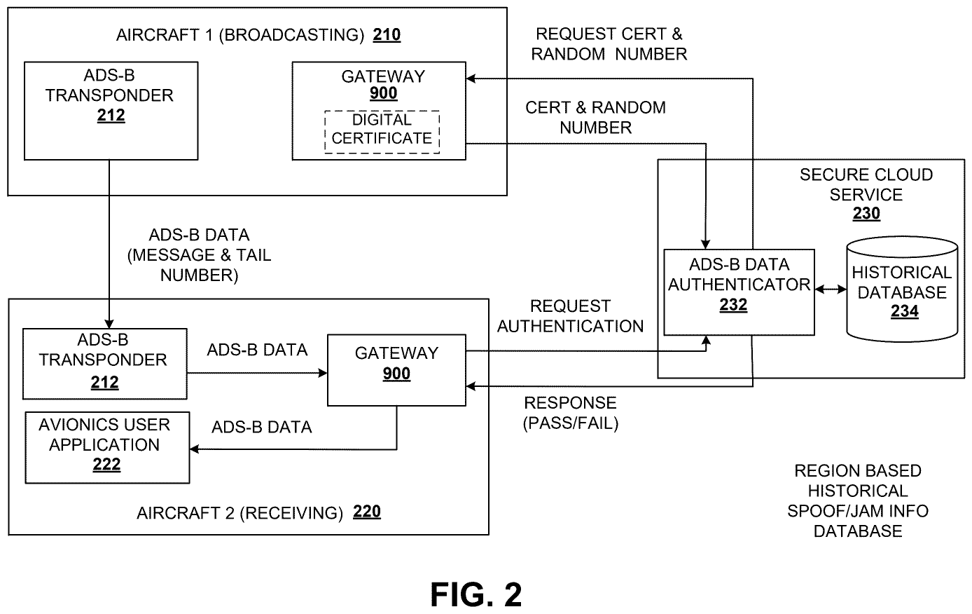

In accordance with one aspect, the FMS cloud services platform 120 can include an authenticator 232 configured to authenticate ADS-B data or senders thereof as described further in FIG. 2.

As indicated above, FIG. 1 is provided merely as an example. Other examples are possible and may differ from what was described with regard to FIG. 1. The number and arrangement of devices and networks shown in FIG. 1 are provided as an example. In practice, there may be additional devices, fewer devices and/or networks, different devices, and/or networks, or differently arranged devices and/or networks than those shown in FIG. 1. Furthermore, two or more devices shown in FIG. 1 (e.g., EFB 1000 and dispatcher device 140) may be implemented within a single device, or a single device shown in FIG. 1 (e.g., EFB 1000, FMS 1102, or dispatcher device 140) may be implemented as multiple, distributed devices. Additionally, or alternatively, a set of devices (e.g., one or more devices) of environment 100 may perform one or more functions described as being performed by another set of devices of environment 100.

FIG. 2 depicts an example system block diagram of an implementation of a security mechanism for ADS-B communication. As shown, the block diagram shows first aircraft 210 (as referred to herein as aircraft 1 or AC1) communicating with second aircraft 220 (also referred to herein as aircraft 2 or AC2), and secure cloud service 230 for securing the communication. First aircraft 210 and second aircraft 220 can correspond to aircraft 101 as described above with respect to FIG. 1 and secure cloud service 230 may correspond to FMS cloud services platform 120.

To establish a foundation for secure communication and context-based data validation, participating aircraft, including first aircraft 210 and second aircraft 220, can initiate a registration process with the secure cloud service 230 or components, systems, or services thereof. As part of a cryptographic setup, secure cloud services can generate and provide an aircraft with a public and private key pair. An aircraft can then provide its tail number or other identifier and public key to a certificate authority to obtain a digital certificate, which can be shared with the secure cloud service 230. An aircraft can also register its identity information and operational data, which can be classified into distinct areas to facilitate contextual analysis. For instance, individual information can be gathered, which may encompass aircraft registration number, aircraft type, and details regarding onboard software and databases. Mission information can include a flight route, operational schedule, and pertinent passenger or crew details. Real-time flight information can also be incorporated to capture the aircraft's dynamic state during operation, such as its current position and fuel status.

Among other things, first aircraft 210 includes ADS-B transponder 212. ADS-B transponder 212 corresponds to an avionics component that broadcasts aircraft data, including the aircraft's position, altitude, and velocity, at regular intervals to ground stations and other aircraft for surveillance and air traffic management purposes. In accordance with one aspect, ADS-B transponder 212 can be configured to broadcast (ADS-B Out) and receive (ADS-B In). In this example, first aircraft 210 is broadcasting ADS-B data by way of ADS-B transponder 212 to second aircraft 220. In accordance with one aspect, ADS-B transponder 212 can continuously transmit the unique tail number (e.g., identifier of an aircraft) of first aircraft 210 along with location reports, enabling surveillance and tracking by receivers. In one instance, the transponder's functionality can be enhanced to also broadcast a public key as part of the data stream, which allows receiving systems to initiate a cryptographic challenge-response sequence to verify that the transmission is coming from the authentic aircraft rather than a spoofed source. However, the unique tail number can be used to obtain the public key from another source rather than broadcasted. As depicted, first aircraft, 210, is the broadcasting aircraft, and second aircraft, 220, is the receiving aircraft.

In accordance with one example implementation, first aircraft 210 (AC1) can broadcast the following ADS-B data: source (AC1), message type (ADS-B Broadcast), tail number (AC1-IN123) of first aircraft 210, message (8040621D58C3820690C8AC2863A7), and type stamp.

```
{
  “source” : “AC1” ,
  “message_type” : “ADS-B Broadcast”,
  “ data” : {
    “tail number” : ″AC1-IN123″,
    “message” : 8040621D58C3820690C8AC2863A7
  },
  “timestamp” : “2023-10-08T12:00:00Z”
}
```

Second aircraft 220 (AC2) can receive the ADS-B data by way of ADS-B transponder 212, configured to receive data (ADS-B In). For example, second aircraft 220 can receive:

```
{
  “source” : “AC2” ,
  “ data” : {
    “message_type” : “ADS-B Received”,
    “received_tail_number” : “AC1-IN123”,
    ″received_message″ : “8040621D58C3820690C8AC2863A7”
  },
  “timestamp” : “2023-10-08T12:00:01Z”
}
```

To verify the received ADS-B data is trustworthy, second aircraft 220 can trigger authentication by providing the ADS-B data to gateway 900, which is configured to communicate with secure cloud services 230. More specifically, the gateway 900 can request ADS-B data authentication from the secure cloud service 230 by way of the ADS-B data authenticator 232 to verify that the data was provided by the first aircraft and not a malicious actor.

Secure cloud service 230, including authenticator 232, refers to a network-accessible, protected computing infrastructure that acts as a trusted third-party intermediary to validate the identity and data integrity of communicating entities, such as first aircraft 210 and second aircraft 220, as well as other entities, such as a ground-based flight tracking service. Secure cloud service 230 provides scalable resources and processing power, encrypted storage, and a secure gateway interface to host authentication safely over a network. In one instance, secure cloud service 230 provides ADS-B data authenticator 232, which provides the software component or engine that executes authentication/verification logic, including cryptographic verification and contextual data analysis. Secure cloud service 230 can provide security frameworks configured to protect data confidentiality, integrity, and availability, utilizing protocols such as public key infrastructure (PKI) encryption and threat monitoring to authenticate devices and validate data exchanges.

Communication with ADS-B data authenticator 232 and secure cloud service 230 is protected by way of encryption. For example, after successfully receiving the ADS-B message, second aircraft 220 (AC2) can extract the tail number and forward this data to the ADS-B data authenticator through a secure gateway along with the original messages. For instance:

```
{
  “source” : “AC2”,
  “destination” : “ADS-B Data Authenticator”,
  “message_type” : “ADS-B Forward”,
  “data” : {
    “tail number” : ″AC1 -IN123″,
    “message” : “8D40621O58C3820690C8AC2863A7”
    },
    “security” : {
      “encryption_method” : “AES-256”,
      “gateway_id” : “gateway-001”
    },
    “timestamp” : “2023-10-08T12:00:02Z”
}
```

Secure cloud services 230 can enable remote clients, such as aircraft avionics, to offload verification tasks while protecting communications against unauthorized access, spoofing, and tampering. In accordance with one implementation, the secure cloud service 230 can be included within or form part of flight management system (FMS) cloud services platform 120 of FIG. 1. As depicted, secure cloud service 230 includes ADS-B data authenticator 232 and historical database 234.

ADS-B data authenticator 232 is configured to determine whether data, and more specifically, the sender of data, is authenticated or unauthenticated. Data provided by an authenticated sender can be said to be verified, validated, or trusted data. By contrast, data provided by an unauthenticated sender can be deemed unverified, invalid, or untrusted data. In accordance with one aspect, the ADS-B data authenticator 232 can employ a multifactor approach to verify a sender's identity, including cryptography, trusted third parties, and data analysis.

After receiving an authentication request, ADS-B data authenticator 232 can request a digital certificate and random value from the first aircraft 210. In accordance with one aspect, a random or pseudo-random value, such as a number, can be generated and encrypted using the public key associated with the first aircraft 210. The random value, number, or nonce (number used once) in the context of a challenge-response protocol is a unique, non-repeating value (numbers, letters, symbols, or a combination thereof) generated to test the authenticity of a sender, such as the first aircraft 210. By sending an unpredictable string of data to the first aircraft 210, ADS-B data authenticator 232 ensures that the response is fresh and generated in real-time, preventing replay attacks, where a malicious actor might attempt to rebroadcast a previously valid authentication message. Furthermore, by encrypting the random value, the first aircraft proves it has the credentials, namely the private key, to generate the random value match to the challenge.

For example, ADS-B data authenticator 232 can act as a validation point and send an encrypted challenge message to first aircraft 210 (AC1) as follows. The challenge can comprise a randomly generated number encrypted with the public key of the first aircraft 210, which uses the corresponding private key to decrypt the randomly generated number.

```
{
  “source” : “ADS-B data authenticator”,
  “destination” : “AC1”,
  “message_type” : “Challenge Message”,
  “data” : {
      “encrypted_ challenge” : “C IYt4YqQhCp1dVZA==”
    },
  “security” : {
      “encryption_method” : “RSA”,
      “public_key” : “-----BEGIN PUBLIC KEY----- \nHIIBijANBgkqhkiG .. . \n-----
  END PUBLIC KEY-----″
  },
  “timestamp” : “2023-10-08T1 2:00:03Z”
}
```

First aircraft 210 can receive the challenge message through gateway 900. Subsequently, the first aircraft 210 can decrypt the encrypted challenge value using its private key and prepare a response that includes the decrypted challenge value, its digital certificate, and the last sent ADS-B message. The prepared response is then sent back to the ADS-B data authenticator 232 to prove legitimacy. For example, the message may be as follows:

```
{
    “source” : “AC1”,
    “destination” : “ADS-B data authenticator”,
    “message_type” : “Challenge Response”,
    “data” : {
      “decrypted_number” : “198274”,
      “tail number” : “ACI -IN123”,
      “message” : “8D40621O58C382O690C8AC2863A7”,
      “digital_certificate” : “ -----BEGIN CERTIFICATE-----
    \nMIICnzCCAYHCFBS . . \n -----END CERTIFICATE -----”
    },
    “security” : {
      “encryption_method_used” : “RSA”,
      “private_key_used” : “ACI_Private_Key”
    },
  “timestamp” : “2023-10-08T12:00:04Z”
}
```

After receiving the challenge response from the first aircraft, ADS-B data authenticator 232 validates the response by comparing the decrypted challenge number with the original one. ADS-B data authenticator 232 can also verify the digital certificate provided by the first aircraft 210 to confirm it is valid and matches the expected parameters. For instance:

```
{
  “source” : “ADS-B data authenticator”,
  “destination” : “Secure cloud service”,
  “message_type” : “Validation”,
  “data” : {
    “tail number” : “ACI - TN123”,
    “message” : “ 8049621D58C3820690CBAC2863A7”,
    “digital_certificate” : {
      “issuer” : “TrustedCA”,
      “certificate_body” : “ -----BEGIN CERTIFICATE----- \nMIICnzCCAVI-
    W::FBS . . . \n - --- -END CERTIFICATE- - -- - ,
      “public_key” : “-----BEGIN PUBLIC KEY-----\nMIIBijANBgkqhkiG .. \n
    -----END PUBLIC KEY-----”
      },
      “validation_status” : “validated”
  },
  “timestamp” : “2023-10-08T12:00:05Z”
}
```

After confirming authenticity of first aircraft 210, ADS-B data authenticator 232 or a separate component or service can compare messages and perform contextual analysis based on validated ADS-B data. More particularly, contextual analysis can be performed that compares the received ADS-B data with expected flight parameters for a route and mission of first aircraft 210, for example, stored in historical database 234, along with region-based historical spoof/jam information. Any discrepancies can be flagged for further investigation and potentially prevent authentication. Alternatively, contextual match information can be provided with a confirmation of authentication to be addressed by the receiver. After authentication and contextual analysis, a message can be sent back to second aircraft 220 confirming that first aircraft 210 is a verified sender. Consider the following example message:

```
{
  “source” : “ADS-B data authentication”,
  “destination” : “AC2” ,
  “message_type” : “Authentication Result”,
  “data” : {
    “tail_number” : “AC1-IN123”,
    “authentication status” : “ true”,
    “contextual match” : “true”,
    “notes” : “ADS-B data and flight parameters align.”
  },
  “time-stamp” : “2023-10-08T12:00:06Z”
}
```

Of course, if it is determined that first aircraft is not a verified sender, the message sent back can indicate that first aircraft 210 is not a verified sender. In other words, the response can indicate whether the authentication passed or failed.

Once the second aircraft 220 receives authentication confirmation, the second aircraft can process the validated data for use in various avionics applications, such as avionics user application 222. Legitimate ADS-B data can be utilized for avionics functions like navigation, tracking, and situational awareness. What follows is an example message:

```
{
  “source”: “AC2”,
  “message_type”: “ADS-B Data Processing”,
  “data” : {
      “tail_number″ : “AC1-1N123”.
      “message”: “8048621058C3820690CBAC2863A7” ,
      “authentication status” : “true”,
      “avionics_integration_status” : “success”
  }.
    “timestamp” : “2023-10-08T12:00:07Z”
}
```

Historical database 234 corresponds to a non-volatile repository for threat intelligence data. Historical database 234 enhances ADS-B authentication by enabling validation of the context of incoming signals against known attack patterns rather than relying solely on cryptographic checks. Historical database 234 can store records of past jamming, spoofing, and rogue agent activities, allowing the secure cloud service to cross-reference current data with historical signatures of malicious behavior. By analyzing the frequency of these events in a particular geographic region, such as high-risk zones in the Middle East, the system can assess the probability of a threat based on how often similar anomalies have occurred in that area previously, effectively flagging data that matches documented attack profiles even if the digital signature appears valid.

Further, historical database 234 facilitates contextual analysis by storing legitimate aircraft parameters and mission profiles alongside threat intelligence. By maintaining a record of an aircraft's filed flight plan, scheduled route or mission intent, and physical capabilities such as maximum speed and altitude, a baseline can be established for every flight. When an aircraft broadcasts ADS-B data, a comparison can be made between reported position and velocity against stored parameters. A deviation such as a commercial airliner appearing in a location impossible to reach within the elapsed time or a general aviation aircraft exceeding its service ceiling can trigger a context mismatch alert, identify the transmission as likely a spoofing attempt regardless of cryptographic validity.

FIG. 2 illustrates one manner of interaction with and use of secure cloud service 230 and ADS-B data authenticator 232. However, other interactions and sequences of interactions are possible and contemplated. For example, consider a situation in which an authentication request is received that includes a broadcasted tail number of a first aircraft and a corresponding digital certificate. The authenticator 232 can first evaluate the digital certificate using a public key of a certificate authority to verify the signature. Additionally, authenticator 232 can check the certificate against a revocation list and verify its expiration data to determine whether the digital certificate remains active. Furthermore, authenticator 232 can cross-reference the tail number provided in the request with the identity embedded in the digital certificate. If the digital certificate passes these evaluations, the authenticator can extract the trusted public key from the certificate. Conversely, if evaluations fail, the process can terminate and reject the data as unverified. After successful validation of the digital certificate, the extracted public key can be utilized to generate the cryptographic challenge, followed potentially by context analysis. By executing certificate validation first, authenticator 232 can efficiently drop requests associated with invalid, expired, or forged certificates and conserve processing power for more computationally intensive challenge-response sequences for entities that have already presented verified credentials.

A mathematical model can describe secure communication and authentication between two aircraft, such as the first aircraft 210 transmitting data and the second aircraft 220 receiving the data, with assistance from secure cloud services, including, but not limited to, ADS-B data authenticator 232 and historical database 234. An objective can be to verify ADS-B data received by the second aircraft 220 is valid, unaltered, and originates from a trusted source.

Entities and variables can include the following:

### Aircraft 1 (Broadcasting)

M: ADS-B message
C_{A1}: CA certificate of Aircraft 1
R: Random challenge issued by the cloud
S_{A1}=Sign_{KA1}(R): Challenge response signed with Aircraft 1's private key

### Aircraft 2 (Receiving)

M′: Received ADS-B message
Aₛₜₐₜᵤₛ: Authentication status from cloud (True/False)

### Secure Cloud Service

Verify(S_{A1},R, C_{A1}): Function to verify the challenge response
Match(M, M′): Function to check if the message received by

Aircraft 2 matches the one sent by Aircraft 1

Given the above variables the process flow can be as follows. To start, first aircraft 210 broadcasts an ADS-B message (Aircraft 1→Broadcast (M)). Next, the second aircraft 220 receives the message and requests authentication (Aircraft 2→Cloud: {M′}). The cloud then issues a challenge (Cloud->Aircraft 2: R). Aircraft 1 can respond to the challenge (Aircraft 1 →Cloud {(S_{A1}, C_{A1}, M)}). Next, the cloud validates the information (Cloud→Verify (S_{A1}, R, C_{A1}) ∧Match (M, M′)). An authentication decision can be made next, which can be either true if verification and match succeed and false otherwise (Aₛₜₐₜᵤₛ {True, if verification and match succeed |False, otherwise). Finally, second aircraft 220 can accept the data (If (Aₛₜₐₜᵤₛ==True) →Aircraft 2 accepts M′). The behavior of this mathematical model is now examined under both nominal and anomalous conditions.

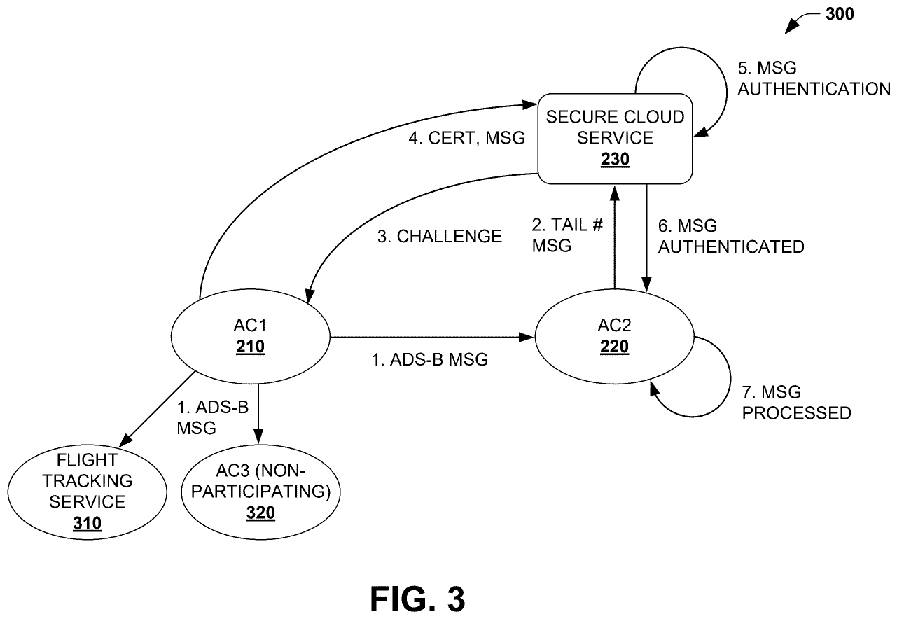

FIG. 3 depicts an example normal ADS-B broadcast 300 involving first aircraft (AC1) 210, second aircraft (AC2) 220, and a secure cloud service 230. The process begins when AC1 210 broadcasts an ADS-B message, which AC2 220 receives. Simultaneously, a third-party flight tracking service 310, and a third aircraft (AC3) 320 that is non-participating also receive the broadcast ADS-B message. Flight tracking service 310 can be any external monitoring system, typically ground-based, that listens to ADS-B broadcasts but is not part of the secure, authenticated system. A non-participating aircraft, such as AC3 320, is a legitimate aircraft operating in the airspace that is not equipped with specific hardware or software, or is not registered to participate in the authentication system. To verify authenticity, AC2 220 forwards the message, along with the tail number of AC1 210, to the secure cloud service 230. Cloud service 230 then initiates a challenge-response protocol by sending a random challenge to AC1 210, requesting its digital certificate and the original message. AC1 210 responds with the requested information, allowing secure cloud service 230 to verify the certificate, validate the challenge response, and confirm that the ADS-B message matches the original broadcast. Once authentication is complete, secure cloud service 230 returns the verification status to AC2 220, enabling secure processing of the message.

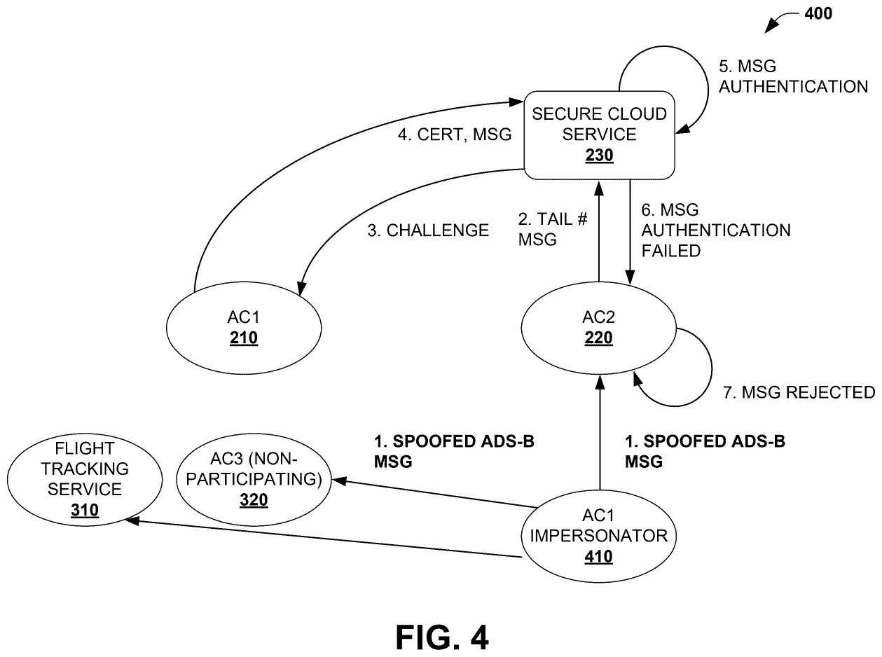

FIG. 4 illustrates an example spoofing attempt 400 involving a spurious ADS-B broadcast within an ADS-B communication system and how a secure authentication mechanism mitigates such threats. In this scenario, AC1 impersonator 410 broadcasts a falsified ADS-B message intended to mislead second aircraft (AC2) 220 and potentially disrupt flight tracking services. Without authentication, such spoofed messages could compromise situational awareness and pose safety risks.

To avoid compromising situational awareness and creating safety risks, AC2 220 forwards the message, along with its tail number, to secure cloud service 230 for validation. Secure cloud service 230 initiates a challenge-response protocol with the legitimate AC1 210, requesting its certificate and original message. Since the impersonator's message does not match the response from AC1 210, secure cloud service 230 detects the discrepancy and flags the message as authentication failed. Consequently, AC2 220 rejects the spoofed message as it processes verified ADS-B data.

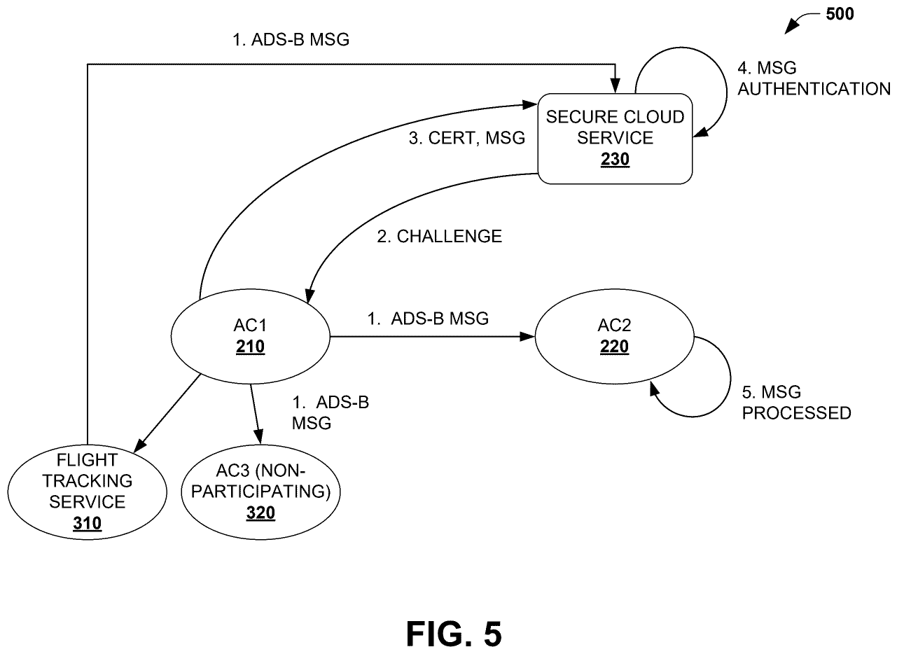

FIG. 5 depicts another normal ADS-B broadcast 500 involving first aircraft (AC1) 210, second aircraft (AC2) 220, and secure cloud service 230. The process begins when AC1 210 broadcasts an ADS-B message that AC2 220 receives. Further, flight tracking application service 310 and non-participating AC3 420 capture the same message. In this scenario, secure cloud service 230 can retrieve the message by way of application programming interfaces from flight tracking service 310 and independently authenticate the message by initiating a challenge-response protocol with AC1 210, requesting its digital certificate and the original message. AC1 210 responds with the challenge response, its digital certificate, and the original message. Secure cloud service 230 validates the challenge response, verifies the digital certificate, and confirms the ADS-B message matches the original broadcast. Since authentication succeeded, secure cloud service 230 takes no further action, and AC2 220 continues to rely on communications from AC1 210 because they have not been flagged as unauthenticated. In other words, in this implementation, secure cloud service 230 can alert aircraft in the vicinity of a compromised aircraft, but until an aircraft is flagged as compromised, receiving aircraft will treat its ADS-B messages as valid for normal operations.

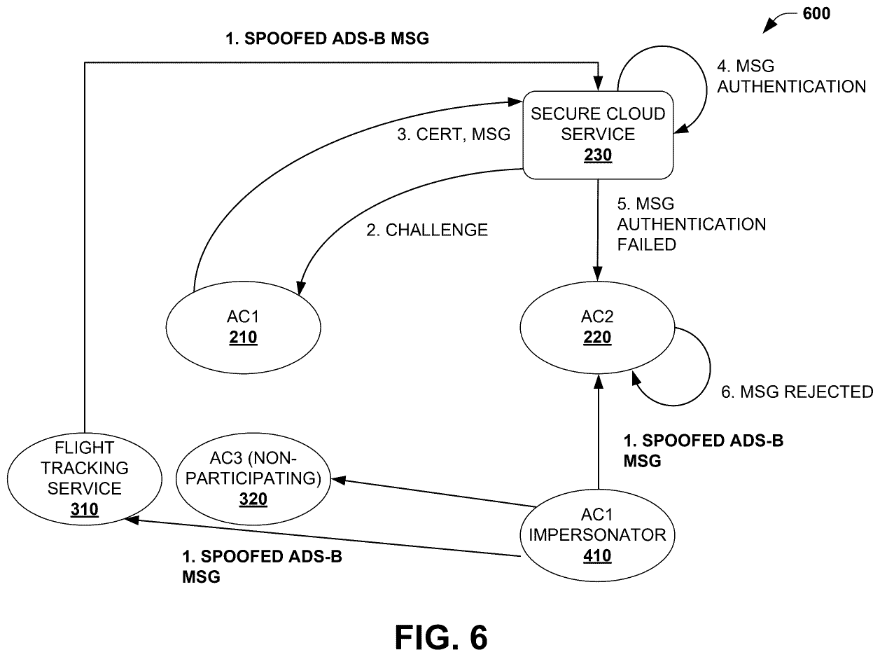

FIG. 6 illustrates an example spoofing attempt 600 involving a spurious ADS-B broadcast within an ADS-B communication system and how a secure authentication mechanism mitigates such threats. Similar to spoofing attempt 400 of FIG. 4, a first aircraft (AC1) impersonator 410 broadcasts a falsified ADS-B message intended to mislead second aircraft (AC2) 220 and potentially influence flight tracking, which could compromise situational awareness and pose safety risks. The workflow begins when the impersonator's ADS-B message is received by AC2 220 as well as flight tracking service 310. In accordance with one implementation, flight tracking service 310 can be configured to forward the ADS-B message to secure cloud service 230. Secure cloud service 230 can then trigger independent authentication of the message by initiating a challenge-response protocol with AC1 210 and requesting its digital certificate and original message. In response to AC1 210 providing requested information, secure cloud service 230 validates the challenge response, verifies the digital certificate, and confirms the ADS-B message matches the original broadcast. In this case, the impersonator's message fails at least because the message provided by AC1 210 does not match the original broadcast. Secure cloud service 230 can flag AC1's communications as compromised and notify participating aircraft that AC1 communications are compromised, resulting in rejection of the spoofed message by AC2 220.

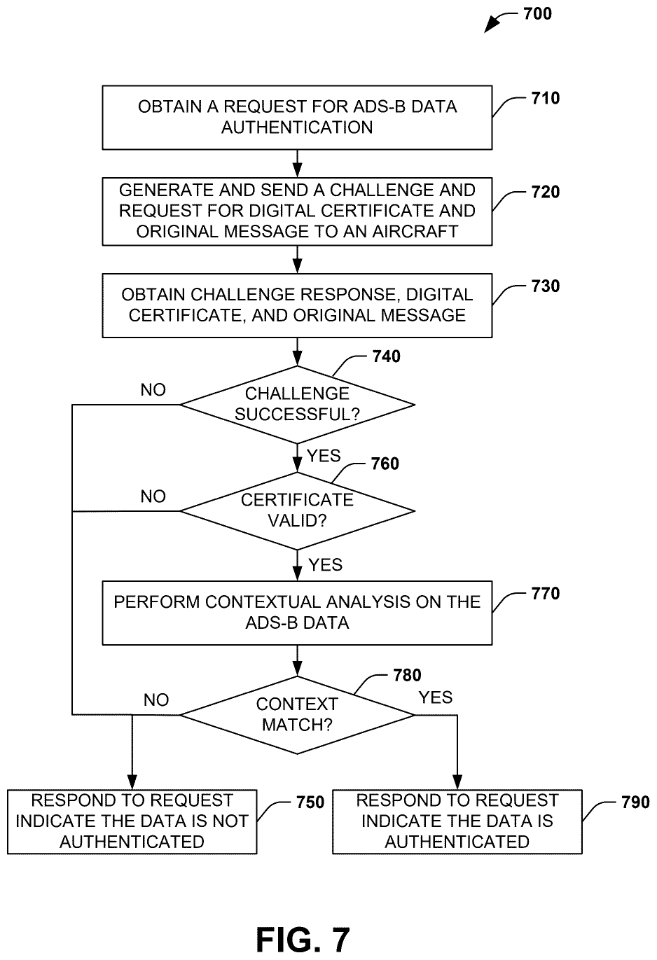

FIG. 7 is a flowchart diagram illustrating an example method 700 of ADS-B data authentication. In accordance with one aspect, method 700 can be implemented by secure cloud service 230, more particularly by ADS-B authenticator 232, alone or in combination with historical database 234.

At block 710, ADS-B authenticator 232 can obtain a request for ADS-B data authentication. In one instance, the request can be obtained from an aircraft that received an ADS-B broadcast message. For instance, a transponder of a first aircraft broadcast the message including tail number and other message data. In another instance, the request can correspond to an ADS-B messages forwarded, for example, by a flight tracking service.

At block 720, ADS-B authenticator 232 generates and sends a challenge along with a request for a digital certificate and the original message to an aircraft that supposedly broadcast the ADS-B message. In one instance, the challenge can be a random value encrypted with the public key of the aircraft. In one instance, the public key can be acquired from a data repository indexed by tail number. Alternatively, an aircraft may broadcast its public key in a regular ADS-B transmission, which can be extracted by the ADS-B data authenticator 232. In yet another instance, ADS-B authenticator 232 can use the tail number to query a certificate authority server for the public key.

At block 730, ADS-B authenticator 232 obtains the challenge response, digital certificate, and original message from the aircraft in response to the request. Subsequently, a multifactor approach can be employed to verify a sender's identity using the obtained data.

At block 740, ADS-B data authenticator 232 determines whether the challenge was successful. The result of the challenge can be determined by comparing the received challenge response with the encrypted, initial response sent to the aircraft. If the provided response matches the initial response, the challenge is successful. Otherwise, the challenge is unsuccessful. If the challenge is successful (“YES”), the method proceeds to block 740. If the challenge is not successful (“NO”), the method can proceed to block 750, where a response provided to the request that indicates the data is not authenticated.

At block 760, ADS-B authenticator 232 determines whether the digital certificate is valid. Determining whether the digital certificate is valid can involve a number of checks including using a public key of a certificate authority to verify the digital signature on the certificate to confirm it was issued by a trusted entity such as a recognized aviation authority, determining whether the certificate is currently active (not expired or revoked), and performing an identity binding check to determine that the certificate includes the tail number. If the certificate is valid (“YES”), the method moves to block 770. If the certificate is invalid (“NO”), the method proceeds to block 750, where the data is reported as unauthenticated.

At block 770, ADS-B authenticator 232 performs contextual analysis of the broadcast ADS-B data. In one instance, the broadcast ADS-B data can be compared to data reported by the aircraft. A mismatch can then indicate potential spoofing by a rogue sender. Additionally, or alternatively, the broadcast data can be compared against a database of previously documented spoofing or jamming information to flag data that matches documented attack profiles. Further, analysis can involve flight mission parameters (e.g., flight route, schedule, passenger/crew information), for example, to detect deviations between the broadcast ADS-B data and the expected aircraft location defined by the filed flight plan.

At block 780, ADS-B authenticator 232 determines whether or not there is a context match. If there is no context match (“NO”) at block 780, the method proceeds to block 750, where ADS-B data authenticator responds to the authentication request with an indication that the data is not authenticated or failed to authenticate. If there is a match (“YES”) at block 780, the method continues at block 790, where the ADS-B data authenticator responds to the request with an indication that the data is authenticated.

Note that FIG. 7 is just one example of a method, and other methods including fewer, additional, or alternative operations are possible consistent with this disclosure.

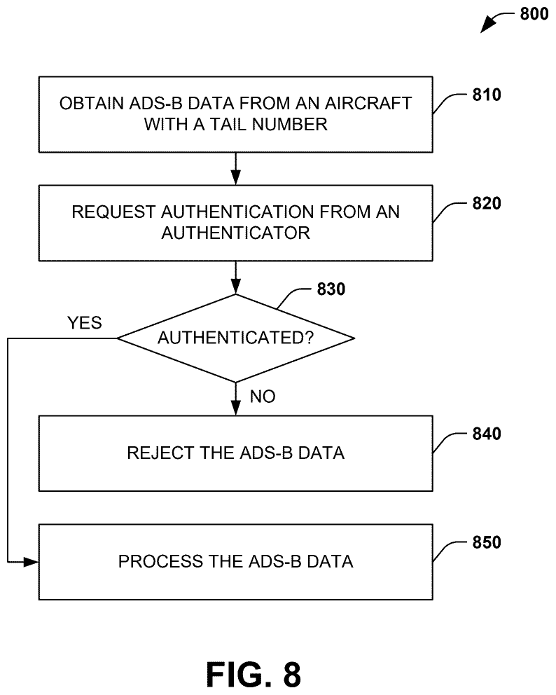

FIG. 8 is a flowchart diagram depicting an example method 800 of ADS-B data interaction. In accordance with one aspect, method 800 can be performed by a receiver of an ADS-B broadcast message from an aircraft, including another aircraft, for instance, by way of an ADS-B transponder 212 and gateway 900.

At block 810, ADS-B transponder 212 obtains ADS-Data from an aircraft with a tail number. ADS-B transponder 212 operating in a receiving mode can monitor specific radio frequences for incoming broadcast signals. After receiving, retrieving, or otherwise obtaining such a broadcast signal, ADS-B transponder 212 can demodulate digital packets to extract a payload, which can include a message and an identifier that functions as an aircraft's tail number.

At block 820, a receiver through gateway 900 can request data authentication from an ADS-B data authenticator. Authentication can be requests since ADS-B broadcasts are transmitted unencrypted, leaving the system vulnerable to spoofing attacks that introduce spurious data. Further, since surveillance data transmitted by ADS-B is relied upon for safety systems such as collision avoidance and situational awareness processing ADS-B data can pose safety hazards. Performing authentication can transform unsecure and untrusted ADS-B data into secure and trusted data. In accordance with one aspect, authentication can be performed as a secure cloud service.

At block 830, a determination is made as to whether the ADS-B data is authenticated or not. If the ADS-B data or more specifically the sender of the ADS-B data is not authenticated (“NO”), the ADS-B data is rejected at block 840. If the ADS-B data, or more particularly, the sender of the ADS-B data is authenticated (“YES”), the ADS-B data can be processed at block 850. Authentication indicates that the sender of the ADS-B data is legitimate, and as such the data can be integrated into flight operations and avionics systems. For example, a collision avoidance system can utilize verified position, altitude, and velocity of the sender to calculate safe separation distances. In another example, a flight management system may ingest verified intent and trajectory of surrounding aircraft to compute optimal flight paths, anticipate turbulence, or adjust cruising speeds.

Note that FIG. 8 is just one example of a method, and other methods including fewer, additional, or alternative operations are possible consistent with this disclosure.

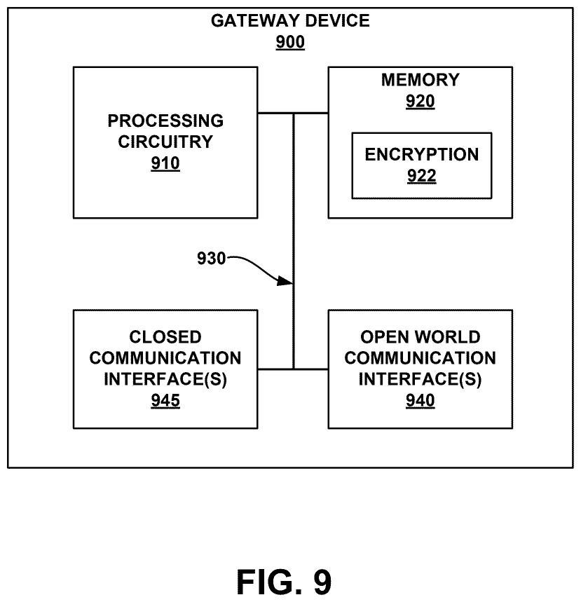

FIG. 9 illustrates an example of gateway device 900 that can be utilized to communicate with a secure cloud service to perform authentication. Although this disclosure presents gateway device 900 as being separate from avionics 1100, in many implementations gateway device 900 may be a component of avionics 1100 or otherwise highly integrated within avionics 1100. Gateway device 900 may, for example, be a subsystem of avionics 1100 that is configured to transmit and receive data from open world sources over internet-based or other open world communications protocols, whereas other subsystems of avionics 1100 are restricted from, or otherwise not capable of, communicating with open world sources. In this regard, gateway device 900 generally represents a boundary between proprietary functions of the avionics and computing systems external to avionics 1100. Gateway device 900 also facilitates communication between various subsystems, e.g., LRUs, of avionics 1100.

Gateway device 900 generally performs the techniques described herein. In the example of FIG. 9, gateway device 900 includes processing circuitry 910, memory 920 which stores encryption application 922, open world communication interface(s) 940, closed world communication interface(s) 945. The aforementioned components of gateway device 900 may be connected to one another through a bus 930, which generally represents one or more buses and is intended to generically represent all the electrical and data connectivity of internal components included within gateway device 900.

Processing circuitry 910 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware, or any combinations thereof. When the techniques are implemented partially in software, gateway device 900 may store instructions for the software in a suitable, non-transitory computer-readable medium (e.g., memory 920) and execute the instructions in hardware using processing circuitry 910 to perform the techniques of this disclosure.

Memory 920 is intended to generically represent all memory included within EFB 1000. In some implementations, memory 920 may include a plurality of separate devices and memory units. These memory devices and memory units may include volatile memory, such as random access memory (RAM), and/or non-volatile memory, such as ROM and storage media. Examples of RAM include dynamic random access memory (DRAM), including synchronous DRAM (SDRAM), magnetoresistive RAM (MRAM), resistive RAM (RRAM). Examples of storage media include solid-state storage media (e.g., solid state drives and/or removable flash memory), optical storage media (e.g., optical discs), and/or magnetic storage media (e.g., hard disk drives). The aforementioned encryption application (shown in FIG. 9 as encryption 922) may be stored in any volatile and/or non-volatile memory component of memory 920.

Gateway device 900 also includes open world communication interface(s) 940 for communicating with EFB 1000 and closed communication interface(s) 945 for communicating with avionics 1100. In this context, open world communication interface(s) 940 generally represents any hardware for communicating via open world protocols. Open world protocols are generally considered to be protocols that are publicly available and usually standardized. Examples of open world protocols include a transmission control protocol/internet protocol (TCP/IP), a hypertext transfer protocol/secure (HTTP/HTTPS), a file transfer protocol (FTP), a secure FTP, a web socket, a constrained application protocol (CoAP), Bluetooth, ZigBee, a network file system (NFS), or the like.

Closed communication interface(s) 945 generally represents any hardware for communicating via closed protocols. In this context, a closed protocol generally refers to a protocol that is proprietary or vendor specific and for which the specifications are not publicly disclosed. A closed protocol is typically intended to limit access to specific vendors or products rather than to grant public access. Closed communication interface(s) 945 may, for example, include a secured bus for communicating directly with various LRUs of avionics 1100. Closed communication interface(s) may, for example, include Aeronautical Radio, Incorporated (ARINC) 429, ARINC 573, ARINC 717, Avionics Full-Duplex Switched Ethernet (AFDX)—ARINC 664, ARINC 818, RS-422, RS-232, Avionics Standard Communications Bus (ASCB).

Gateway device 900 may be configured to act as a bridge or translator between different avionics systems of avionics 1100. Avionics 1100 may include a wide array of electronic systems from different manufacturers, often using different communication protocols and data formats. Gateway device 900 may enable these systems to communicate effectively and securely. Processing circuitry 910 may, for example, perform protocol conversion between different avionics communication protocols. Processing circuitry 910 may also perform data translation by translating the format or structure of data to match what a receiving system expects (e.g., converting GPS data into a usable format for the flight management system). Processing circuitry 910 may also perform security filtering by acting as a firewall between different systems, including between open systems (e.g., Wi-Fi, external data links) and critical flight systems, enforcing cybersecurity policies. Processing circuitry 910 may also perform data routing by routing data to the correct systems, ensuring time-sensitive or high-priority data reaches its destination reliably and efficiently. Processing circuitry 910 may also perform redundancy and fault management to help maintain system resilience by providing alternate communication paths and monitoring for data integrity or faults. Processing circuitry 910 may also act as an interface between legacy systems and newer systems.

In accordance with one aspect, the gateway device 900 can receive ADS-B data and request ADS-B data authentication from an authenticator. Further, the gateway device 900 can receive and respond to requests for a digital certificate and a challenge to aid in authentication.

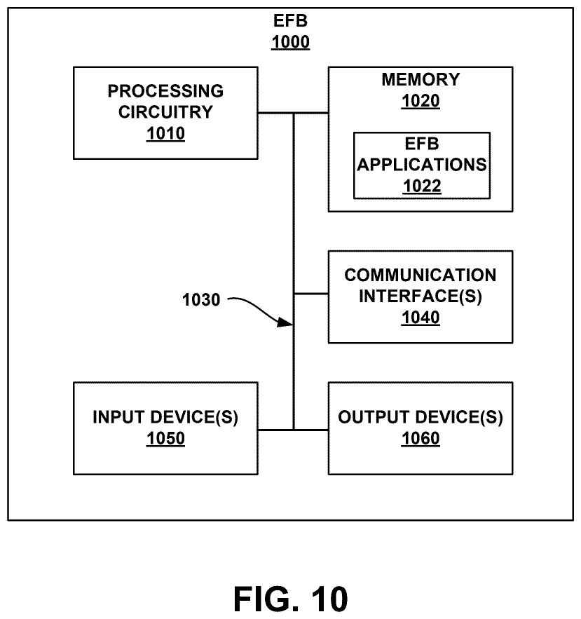

FIG. 10 illustrates an example of EFB 1000. EFB 1000 may be any sort of generic computing hardware, such as a tablet computer, phone, laptop computer, desktop computer, or other such computing device that is configured to store and execute EFB applications. EFB 1000 may, for example, be a commercially available iOS® device or Android® device executing specialized electronic flight bag software. In other examples, EFB 1000 may be specialized computing hardware configured to store and execute EFB applications. Some EFBs may be portable and be able to be carried from plane to plane, while other EFBs may be permanently mounted in a specific airplane. In the example of FIG. 10, EFB 1000 includes processing circuitry 1010, memory 1020 which stores EFB applications 1022, and communication interface(s) 1040 to communicate with other devices, such as gateway device 900.

Processing circuitry 1010 implements the functionality of and/or executes the instructions associated with EFB applications 1022. Processing circuitry 1010 may be implemented as any of a variety of suitable circuitry that includes a processing system, such as one or more integrated circuits, microprocessors, DSPs, ASICs, FPGAs, discrete logic, software, hardware, firmware, or any combinations thereof. When the techniques are implemented partially in software, EFB 1000 may store instructions for the software in a suitable, non-transitory computer-readable medium (e.g., memory 1020) and execute the instructions in hardware using processing circuitry 1010 to perform the techniques of this disclosure.

Memory 1020 is intended to generically represent all memory included within EFB 1000. In some implementations, memory 1020 may include a plurality of separate devices and memory units. These memory devices and memory units may include volatile memory, such as RAM), and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned EFB application (shown in FIG. 10 as EFB applications 1022) may be stored in any volatile and/or non-volatile memory component of memory 1020.

EFB 1000 also includes input device(s) 1050 (e.g., a keyboard, mouse, or touchscreen) and output device(s) 1060 (e.g., a display, printer). In implementations where EFB 1000 is a phone or tablet computer, then the EFB may, for example, have a touchscreen and a display. In implementations where EFB 1000 is a larger computer device, then the EFB may, for example, have a mouse, trackpad, keyboard, or other such input devices. The aforementioned components of EFB 1000 may be connected to one another through a bus 1030, which generally represents one or more buses and is intended to generically represent all the electrical and data connectivity of internal components included within EFB 1000.

Communication interface(s) 1040 generally represents all hardware, e.g., transceiver circuitry, within EFB 1000 for communicating with external devices. Communication interface(s) 1040 may facilitate communication with external devices via one or more wired and/or wireless network connections by transmitting and/or receiving signals on the one or more networks. Examples of communication interface(s) 1040 include a network interface card (e.g., such as an Ethernet card), an optical transceiver, a radio frequency transceiver, a GPS receiver, or any other type of device that can send and/or receive information. Other examples of communication interface(s) 1040 may include short wave radios, cellular data radios, wireless network radios, as well as USB controllers.

EFB applications 1022 represent a suite of software tools that may be used by a pilot in managing flight operations. EFB applications 1022 may include flight planning applications that allow pilots to create and file flight plans, access weather information, and calculate fuel requirements. EFB applications 1022 may also include navigation applications that provide real-time navigation support with maps, airspace information, and waypoint management. EFB applications 1022 may also include weather applications that provide real-time weather data, future weather predictions, radar imagery, and the like. EFB applications 1022 may also include checklist applications for ensuring compliance with pre-flight, mid-flight, and post-flight procedures. EFB applications 1022 may also include various performance analysis tools that, for example, help pilots compute takeoff and landing distances based on current conditions and aircraft configuration. EFB applications 1022 may also include aircraft maintenance tracking tools that track aircraft maintenance schedules, inspection records, and compliance records. EFB applications 1022 may also include flight logbooks that enable pilots to log flights, track hours, and generate reports for currency and certification. EFB applications 1022 may also include airport information applications that provide information about airports, including runway layouts, services, and notices.

Examples of applications that may be included in EFB applications 1022 are Honeywell GoDirect Flight Services®, Honeywell GoDirect Cockpit®, Honeywell Flight Bag®, Honeywell JetWave®, and Honeywell SmartView®. The various example applications listed above represent a non-exhaustive list of the types of applications that may be included in EFB applications 1022. As explained above, some applications of EFB applications 1022 may facilitate communication with avionics 1100 using the data communication techniques of this disclosure.

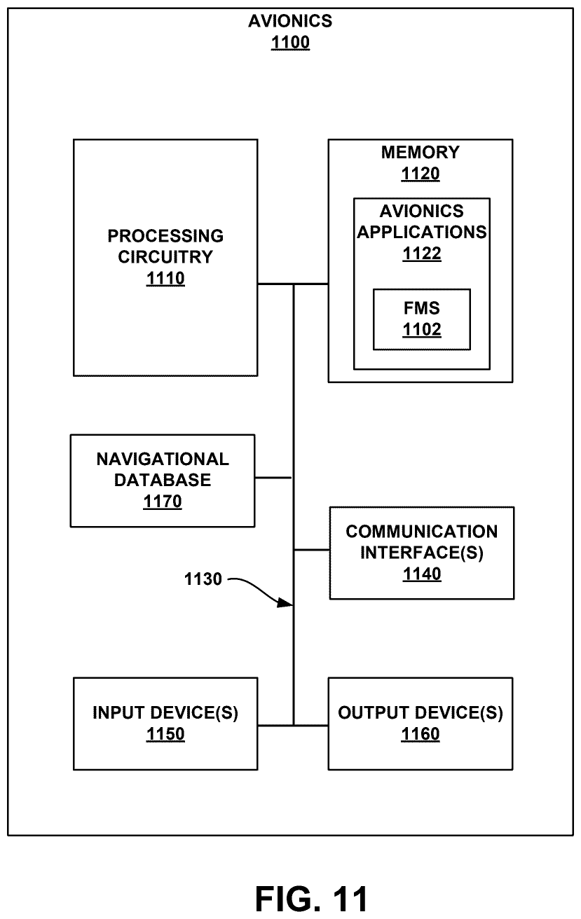

FIG. 11 illustrates an example of avionic 1100. Avionics 1100 represents specialized computing hardware configured to store and execute avionics applications. In the example of FIG. 11, avionics 1100 includes processing circuitry 1110, memory 1120 which stores avionics applications 1122, communication interface(s) 1140 to communicate with other devices, such as gateway device 900, input device(s) 1150, output device(s) 1160, and navigational database 1170. The aforementioned components of avionics 1100 may be connected to one another through a bus 1130, which generally represents one or more buses and is intended to generically represent all the electrical and data connectivity of internal components included within avionics 1100.

Processing circuitry 1110 implements the functionality of and/or executes the instructions associated with avionics applications 1122. Processing circuitry 1110 generally represents all processing circuitry within avionics 1100 and may be distributed across multiple subsystems, e.g., multiple LRUs, within avionics 1100. For example, processing circuitry 1110 may include a first processor in a first LRU and a second processor in a second LRU.

Processing circuitry 1110 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware, or any combinations thereof. When the techniques are implemented partially in software, avionics 1100 may store instructions for the software in a suitable, non-transitory computer-readable medium (e.g., memory 1120) and execute the instructions in hardware using processing circuitry 1110 to perform the techniques of this disclosure.

Avionics applications 1122 include FMS 1102. FMS 1102 may automate certain aspects of flight planning, navigation, performance management, and aircraft guidance to reduce pilot workload by optimizing and controlling various aspects of a flight. In some instances, FMS 1102 may control autopilot functionality of the aircraft, whereas in other instances, FMS 1102 may generate recommendations that require pilot approval prior to being implemented. Prior to takeoff, a pilot may input a flight plan into FMS 1102, with the flight plan including waypoints, airways, altitude constraints, a destination, and other such information.

Memory 1120 is intended to generically represent all memory included within avionics 1100. In some implementations, memory 1120 may include a plurality of separate devices and memory units. In some examples, these separate devices and memory units may be components of different LRUs included within avionics 1100. These memory devices and memory units may include volatile memory, such as RAM, and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned avionics application (shown in FIG. 11 as avionics applications 1122) may be stored in any volatile and/or non-volatile memory component of memory 1120. In accordance with one aspect of the disclosure, the avionics 1100 comprising avionics applications 1122 may correspond to or include ADS-B data avionics user application 222 of FIG. 2

Communication interface(s) 1140 generally represents all hardware e.g., transceiver circuitry, within avionics 1100 for communicating with external devices either on the ground or while in flight. Communication interface(s) 1140 may facilitate communication with external devices via one or more wired and/or wireless network connections by transmitting and/or receiving signals on the one or more networks. Examples of communication interface(s) 1140 include a network interface card (e.g., such as an Ethernet card), an optical transceiver, a radio frequency transceiver, a GPS receiver, or any other type of device that can send and/or receive information. Other examples of communication interface(s) 1140 may include short wave radios, cellular data radios, wireless network radios, as well as USB controllers. Examples of communication interface(s) 1140 for in-flight communication include a very high frequency (VHF) radio, a high frequency (HF) radio, or a satellite communication (SATCOM) radio.

Examples of communication interface(s) 1140 used for data links include an aircraft communications addressing and reporting system (ACARS) for providing a digital data link system that allows for the exchange of messages between the aircraft and ground stations for purposes such as flight plan updates, weather information, and maintenance reports. Another examples of communication interface(s) 1140 used for data links include controller-pilot data link communications (CPDLC) which allows air traffic control to send instructions and receive acknowledgments from pilots via text messages. Communications interface(s) 1140 may also include an automatic dependent surveillance-broadcast transponder. The various examples of communications interfaces listed above represent a non-exhaustive list of the types of communication interfaces that may be included in communication interface(s) 1140.

In accordance with one aspect, communications interface(s) can send ADS-B data (ADS-B Out) and receive ADS-B data (ADS-B In). Further, in accordance with a disclosed aspect, the avionics 1100 can be configured to operate over secure data that has been authenticated to at least mitigate spoofed or corrupted data that may lead to false alarms and pilot distractions during critical phases of flight.

Avionics 1100 also includes input device(s) 1150 and output device(s) 1160. Examples of input device(s) 1150 include control display units (CDUs) with alphanumeric keypads or touchscreens to enter flight plans, waypoints, and other necessary data. Input device(s) 1150 may also include an FMS control panel for entering information to the FMS, such as route, altitude, and speed using dedicated buttons, knobs, and touchscreen interfaces. Input device(s) 1150 may also include yoke or sidestick controls as well as touchscreen interfaces. Input device(s) 1150 may also include rotary knobs for setting values for altitudes, speeds, and other parameters and toggle switches for selecting modes or turning systems on and off.

Examples of output device(s) 1160 may include an electronic flight instrument display to provide visual representations of flight data, including altitude, air speed, heading, and attitude. Output device(s) 1160 may also include a Heads-Up Display (HUD) that projects critical flight information onto a transparent screen in the pilot's line of sight or other cockpit displays to show navigation maps, engine parameters, system statuses, and the like. Output device(s) 1160 may also include engine instrumentation displays to display data on engine performance, such as temperature, pressure, and revolutions per minute (RPMs). Output device(s) 1160 may also include audio panels to relay communication from radios and alerts from systems to the cockpit. Output device(s) 1160 may also include an FMS display to show flight plan information and performance data, as well as a traffic collision avoidance system (TCAS) display to alert pilots to nearby aircraft and potential collision threats.

The various examples of input and output devices listed above represent a non-exhaustive list of the types of input and output devices that may be included in input device(s) 1150 and output device(s) 1160. Additionally, input and output functionality of avionics 1100 may be facilitated by external devices that are separate from input device(s) 1150 and output device(s) 1160. For example, EFB 1000 may be configured to input data to and output data for avionics 1100.

Avionics applications 1122 represent a suite of software tools that may be used by a pilot in managing flight operations and managing the aircraft while in flight. Avionics applications 1122 includes FMS 1102 discussed above as well as other applications for communication, navigation, and monitoring within an aircraft. Avionics applications 1122, for example, include applications for processing and displaying weather radar data and presenting essential flight information such as altitude, air speed, attitude, and heading to a pilot. Avionics applications 1122 also include various safety applications related to surveillance systems (e.g., transponders to communicate the aircraft's identity and altitude to air traffic control and other aircraft, such as automatic dependent surveillance-broadcast (ADS-B) systems that provide real-time data to air traffic control and other aircraft). Avionics applications 1122 may also include software to manage various emergency systems (e.g., an emergency locator transmitter, flight data recorder, and cockpit voice recorder) and cabin management systems (e.g., passenger infotainment systems and environmental control systems).

Navigational database 1170 represents a specialized database that stores information needed by FMS 1102 for the navigation and operation of an aircraft for purposes such as flight planning, route management, and ensuring safe navigation throughout a flight. Navigational database 1170 may, for example, store navigational data according to the ARINC standard, which specifies how navigation data, such as waypoints, airways, terminal procedures, and navigational aids, and other such data, is stored and transmitted.

Navigational database 1170 may, for example, store waypoints, airways, navigational aids, airport information, standard instrument departures (SIDs) and standard terminal arrival routes (STARs), route data, and flight plans. The waypoints represent information on predefined geographical locations used for navigation, including both en-route waypoints and arrival/departure waypoints. The airways are data defining structured flight paths in the sky, including various air routes, and connecting points. The navigational aids may, for example, be information on radio beacons, such as VHF Omnidirectional Range and Instrument Landing Systems that assist pilots in navigation. The airport information may, for example, include details about airports, including runway configurations, elevation, communications frequencies, and available approaches. SIDs and STARs may provide standardized paths for departures and arrivals. The route data may, for example, include information on preferred routes, including distance and estimated times. The flight data may be data regarding planned routes, altitudes, and waypoints for a specific flight. The locations of waypoints, airports, and navigational aids may, for example, be defined by geographical coordinates.

Navigational database 1170 may also store information related to restrictions and procedures, performance data, and weather information. The restrictions and procedures may include airspace restrictions, no-fly zones, and specific procedures that need to be followed during flight. The performance data may include information related to aircraft performance, including altitude constraints, and speed limits. The weather information may include relevant meteorological data that might affect flight paths, such as wind patterns or turbulence zones. Navigational database 1170 may be regularly updated to reflect changes in air traffic regulations, airport information, and navigational aids to ensure pilots have current information for safe and efficient flight operations.

Although not explicitly shown in FIG. 11, avionics 1100 may include or be in communication with numerous other hardware components or hardware systems, such as a global positioning system (GPS) receiver, an inertial navigation system (INS) that includes gyroscopes and accelerometers to calculate position based on movement, weather radar for detecting weather patterns, engine monitoring systems, aircraft data recording systems, flight data recording systems, and other such systems. In some examples, avionics 1100 may be configured to utilize inputs from a variety of specialized sensors such as altitude sensors, airspeed sensors, attitude sensors, heading sensors, GPS sensors, temperature sensors, pressure sensors, fuel sensors, weight and balance sensors, navigation sensors, environmental sensors, collision avoidance sensors, and other such sensors.

Avionics 1100 may be configured to securely receive data uploads from EFB 1000 via gateway device 900. Processing circuitry 1110 may receive, via communication interface(s) 1140, a request to establish a communication session with gateway device 900. Processing circuitry 1110 may generate an encryption key in response to receiving the request. Processing circuitry 1110 may cause communication interfaces 1140 to transmit the encryption key to gateway device 900. Processing circuitry 1110 may receive an encrypted avionics command from the computing device and decrypt the encrypted version of the avionics command, using a decryption key corresponding to the encryption key, to determine a decrypted version of the avionics command. Processing circuitry 1110 executes the decrypted avionics command by, for example, modifying a flight plan being managed by FMS 1102.

The disclosed authentication process extends to operational integrity of a receiving aircraft's onboard avionics 1100. For example, after receiving and processing an ADS-B broadcast, authenticator 232 can act as a secure gateway interfacing with avionics bus 1130. If a received data packet fails multi-factor authentication, authenticator 232 may designate the packet as unverified or spurious. Consequently, authenticator 2232 can quarantine or drop this unverified data back at the network edge, preventing transmission across the avionics bus 1130. Filtering of unverified traffic prior to downstream processing provides a technical improvement to the functioning of an aircraft's safety-sensitive applications. For instance, by preventing unverified positional data from reaching the Traffic Alert and Collision Avoidance System (TCAS), the system mitigates the risk of the TCAS algorithmically calculating a false trajectory and issuing an erroneous, hazardous Resolution Advisory (RA) based on a spoofed “ghost” aircraft. Furthermore, dropping invalid packets at the gateway level reduces the overall processing overhead on the flight management computers, conserving valuable computational cycles and bandwidth on the avionics network for legitimate, authenticated flight operations.

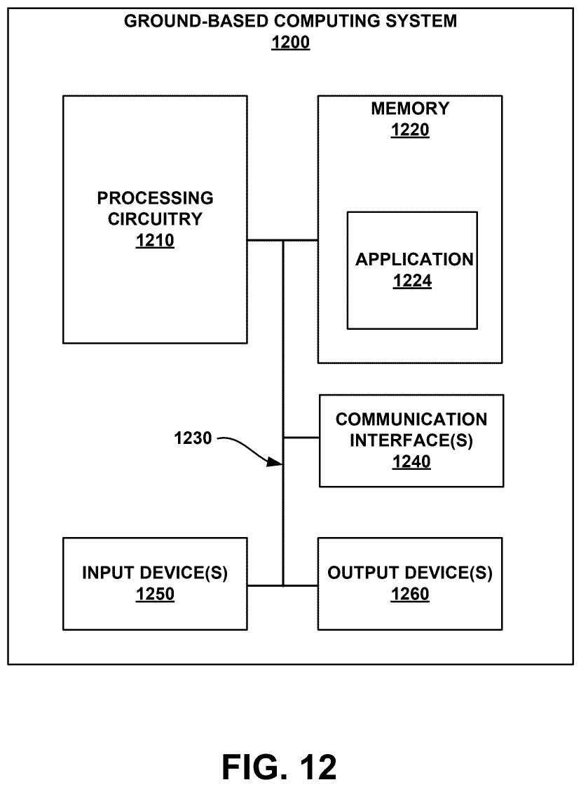

FIG. 12 is a block diagram illustrating an example of ground-based computing system 1200. Ground-based computing system 1200 may represent generic hardware (e.g., a general-purpose microprocessor) or specifically designed computing hardware (e.g., an application specific integrated circuit (ASIC)) configured to safeguard ADS-B data communication. In the example of FIG. 12, ground-based computing system 1200 includes processing circuitry 1210, memory 1220, communication interface(s) 1240, input device(s) 1250, and output device(s). The aforementioned components of ground-based computing system 1200 may be connected to one another through a bus 1230, which generally represents one or more buses and is intended to generically represent all the electrical and data connectivity of internal components included within ground-based computing system 1200.

Processing circuitry 1210 implements the functionality of and/or executes the instructions associated with safeguarding ADS-B data communication. Processing circuitry 1210 may be implemented as any of a variety of suitable circuitry that includes a processing system, such as one or more integrated circuits, microprocessors, digital signal processors (DSPs), ASICs, field programmable gate arrays (FPGAs), discrete logic, software, hardware, firmware, or any combinations thereof. When the techniques are implemented partially in software, ground-based computing system 1200 may store instructions for the software in a suitable, non-transitory computer-readable medium (e.g., memory 1220) and execute the instructions in hardware using processing circuitry 1210 to perform the techniques of this disclosure.

Memory 1220 is intended to generically represent all memory included within ground-based computing system 1200. In some implementations, memory 1220 may include a plurality of separate devices and memory units. These memory devices and memory units may include volatile memory, such as random access memory (RAM), and/or non-volatile memory, such as ROM and storage media. Examples of RAM include dynamic random access memory (DRAM), including synchronous DRAM (SDRAM), magnetoresistive RAM (MRAM), resistive RAM (RRAM). Examples of storage media include solid-state storage media (e.g., solid state drives and/or removable flash memory), optical storage media (e.g., optical discs), and/or magnetic storage media (e.g., hard disk drives). ADS-B data authenticator 232 may be stored in any volatile and/or non-volatile memory component of memory 1220 and executed by processing circuitry 1210. In one instance, the ADS-B data authenticator 232 can be implemented within or form part of application 1224 configured to safeguard ADS-B communication.

Communication interface(s) 1240 generally represents some or all communication hardware, e.g., transceiver circuitry, within ground-based computing system 1200 for communicating with external devices. Communication interface(s) 1240 may facilitate communication with external devices via one or more wired and/or wireless network connections by transmitting and/or receiving signals on the one or more networks. Examples of communication interface(s) 1240 include a network interface card (e.g., such as an Ethernet card or WiFi card), an optical transceiver, a radio frequency transceiver, or any other type of device that can send and/or receive information. Other examples of communication interface(s) 1240 may include short wave radios, cellular data radios, wireless network radios, as well as USB controllers.

In the example of FIG. 12, ground-based computing system 1200 also includes input device(s) 1250 (e.g., a keyboard, mouse, or touchscreen) and output device(s) 1260 (e.g., a display, printer, etc.). The various examples of input and output devices listed above represent a non-exhaustive list of the types of input and output devices that may be included in input device(s) 1250 and output device(s) 1260.

In accordance with the techniques of this disclosure, ground-based computing system 1200 may be configured to receive a request to authenticate automatic dependent surveillance-broadcast (ADS-B) data, wherein the request includes a public key associated with an aircraft, generate a random number, encrypt the random number with the public key to produce an encrypted random number, send a challenge message to the aircraft with the encrypted random number, receive a decrypted random number in response to the challenge message, perform a comparison of the decrypted random number to the random number, in response to the comparison indicating a challenge match, determine the ADS-B data as being sent by an authenticated sender, in response to the comparison indicating a challenge mismatch, determine the ADS-B data as being sent by an unauthenticated sender, and returning an indication of authenticated or unauthenticated in response to the request to authenticate based on determining the ADS-B data as being sent by an authenticated sender or an unauthenticated sender. The ground-based computing system 1200 may be configured to receive a digital certificate responsive to a second request for the digital certificate from the aircraft, perform an evaluation of the digital certificate against a tail number, wherein the request to authenticate the ADS-B data includes the tail number associated with the aircraft, in response to the evaluation indicating a certificate match and the comparison indicating a challenge match, determine the ADS-B data as being sent by an authenticated sender, and in response to the evaluation indicating a certificate mismatch, determine the ADS-B data as being sent by an unauthenticated sender. Further, the ground-based computing system 1200 may be configured to perform a second evaluation of the ADS-B data against flight mission parameters of the aircraft, in response to the second evaluation indicating a flight mission match, the evaluation of the digital certificate indicating a certificate match, and the comparison indicating a challenge match, determine the ADS-B data as being sent by an authenticated sender, and in response to the second evaluation indicating a flight mission mismatch, determine the ADS-B data as being sent by an unauthenticated sender.

Although ground-based computing system 1200 is shown in the example of FIG. 12 as being a single device, in many implementations, the functionality attributed to the ground-based computing system 1200 may be performed across multiple devices at multiple locations. For example, ground-based computing system 1200 may be distributed across multiple ground stations. From the perspective of aircraft 101, ground-based computing system 1200 may be a cloud device or cloud system that provides aircraft 101 with cloud-based services.

Although much of the discussion has focused on aircraft-to-aircraft communication, disclosed aspects are also applicable to enhancing the security of data transmission between aircraft and ground systems and to verifying the integrity, confidentiality, and authenticity of communications. For instance, data integrity and authentication measures can be applied to the Aircraft Communications Addressing and Reporting System (ACARS) to verify that messages are genuine, protect sensitive data from unauthorized access, and enforce access control to mitigate spoofing and unauthorized communication. For controller-pilot data link communications (CPDLC), message authenticity can also be verified to confirm trusted sources, and text-based communication can be secured against interception or manipulation. Pilot reports (PIREP) can also undergo source validation to verify reports are submitted by authenticated pilots, data consistency checks against existing weather models, and secure transmission and storage of sensitive weather data. Weather uplinks can also be safeguarded to verify the accuracy and integrity of meteorological information, with authentication of the origin of updates to mitigate the spread of false or malicious data. Flight management system (FMS) data transfers can also include access restrictions to mitigate unauthorized modifications to flight plans, performance data, and navigation databases.

The disclosed security framework introduces several aspects to enhance the integrity, confidentiality, and authenticity of data transmission between aircraft and ground systems. In one instance, the security framework is implemented as a secure cloud service to implement robust authentication mechanisms, including multifactor authentication, real-time data validation, and user pre-registration to identify and block unauthorized transmissions. The framework incorporates geographical intelligence to assess region-specific risks and verify transmitted data against the actual location of the sender. The security framework also supports tailored security levels, allowing users to select a desired level of protection based on operational needs, providing flexibility for diverse use cases. Additionally, the system can detect and prevent spoofing attempts, ensuring only verified data is used for critical flight operations. These advancements address vulnerabilities in existing systems while maintaining operational efficiency and accessibility for all aviation stakeholders.

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for authenticating automatic dependent surveillance —broadcast (ADS-B) data, comprising:
receiving a request to authenticate the ADS-B data;
generating a random value;
encrypting the random value with a public key associated with an aircraft to produce an encrypted random value;
sending a challenge message to the aircraft with the encrypted random value;
receiving a decrypted random value response to the challenge message;
performing a comparison of the decrypted random value to the random value;
in response to the comparison indicating a challenge match, determining the ADS-B data as being sent by an authenticated sender;
in response to the comparison indicating a challenge mismatch, determining the ADS-B data as being sent by an unauthenticated sender; and
returning an indication of authenticated or unauthenticated in response to the request based on determining the ADS-B data as being sent by an authenticated sender or an unauthenticated sender.

2. The method of claim 1, further comprising:
receiving a digital certificate from the aircraft with the decrypted random value;
performing an evaluation of the digital certificate against a tail number, wherein the request to authenticate the ADS-B data includes the tail number associated with the aircraft;
in response to the evaluation indicating a certificate match and the comparison indicating a challenge match, determining the ADS-B data as being sent by an authenticated sender; and
in response to the evaluation indicating a certificate mismatch, determining the ADS-B data as being sent by an unauthenticated sender.

3. The method of claim 2, further comprising:
performing a second evaluation of the ADS-B data against flight mission parameters of the aircraft;
in response to the second evaluation indicating a flight mission match, the evaluation of the digital certificate indicating a certificate match, and the comparison indicating a challenge match, determining the ADS-B data as being sent by an authenticated sender; and
in response to the second evaluation indicating a flight mission mismatch, determining the ADS-B data as being sent by an unauthenticated sender.

4. The method of claim 3, further comprising receiving the flight mission parameters of the aircraft before starting flight.

5. The method of claim 2, further comprising:
performing a second evaluation of the ADS-B data against a known attack pattern;
in response to the second evaluation indicating a pattern mismatch, the evaluation of the digital certificate indicating a certificate match, and the comparison indicating a challenge match, determining the ADS-B data as being sent by an authorized user; and
in response to the second evaluation indicating a pattern match, determining the ADS-B data as being sent by an unauthenticated sender.

6. The method of claim 1, further comprising:
obtaining a digital certificate based on a tail number of the aircraft provided in the request to authenticate;
validating the digital certificate; and
obtaining the public key associated with the aircraft from the digital certificate.

7. The method of claim 1, wherein the request is received from a receiver aircraft that receives the ADS-B data from a sender aircraft that sends the ADS-B data to the receiver aircraft.

8. The method of claim 1, wherein the request to authenticate is received from a flight tracking service in response to ADS-B data broadcast by the aircraft.

9. The method of claim 8, further comprising:
determining the ADS-B data is unverified based on an unauthenticated sender; and
notifying other participating aircraft of the unverified ADS-B data.

10. The method of claim 1, wherein the encrypted random value is decrypted with a private key associated with the aircraft, resulting in a challenge match.

11. A system, comprising:
at least one processor implemented in circuitry;
at least one memory coupled to the at least one processor that stores instructions that, when executed by the at least one processor, cause the system to:
receive a request to authenticate automatic dependent surveillance-broadcast (ADS-B) data;
generate a random value;
encrypt the random value with a public key of an aircraft to produce an encrypted random value;
send a challenge message to the aircraft with the encrypted random value;
receive a decrypted random value in response to the challenge message;
perform a comparison of the decrypted random value to the random value;
in response to the comparison indicating a challenge match, determine the ADS-B data as being sent by an authenticated sender;
in response to the comparison indicating a challenge mismatch, determine the ADS-B data as being sent by an unauthenticated sender; and
returning an indication of authenticated or unauthenticated in response to the request to authenticate based on determining the ADS-B data as being sent by an authenticated sender or an unauthenticated sender.

12. The system of claim 11, wherein the instructions further cause the system to:
receive a digital certificate from the aircraft with the decrypted random value;
perform an evaluation of the digital certificate against a tail number, wherein the request to authenticate the ADS-B data includes the tail number associated with the aircraft;
in response to the evaluation indicating a certificate match and the comparison indicating a challenge match, determine the ADS-B data as being sent by an authenticated sender; and
in response to the evaluation indicating a certificate mismatch, determine the ADS-B data as being sent by an unauthenticated sender.

13. The system of claim 12, wherein the instructions further cause the system to:
perform a second evaluation of the ADS-B data against flight mission parameters of the aircraft;
in response to the second evaluation indicating a flight mission match, the evaluation of the digital certificate indicating a certificate match, and the comparison indicating a challenge match, determine the ADS-B data as being sent by an authenticated sender; and
in response to the second evaluation indicating a flight mission mismatch, determine the ADS-B data as being sent by an unauthenticated sender.

14. The system of claim 13, wherein the instructions further cause the system to receive the flight mission parameters of the aircraft before starting flight.

15. The system of claim 12, wherein the instructions further cause the system to:
perform a second evaluation of the ADS-B data against a known attack pattern;
in response to the second evaluation indicating a pattern mismatch, the evaluation of the digital certificate indicating a certificate match, and the comparison indicating a challenge match, determine the ADS-B data as being sent by an authorized user; and
in response to the second evaluation indicating a pattern match, determine the ADS-B data as being sent by an unauthenticated sender.

16. The system of claim 11, wherein the request is received from a receiver aircraft that receives the ADS-B data from a sender aircraft that sends the ADS-B data to the receiver aircraft.

17. The system of claim 11, wherein the request to authenticate is received from a flight tracking service in response to ADS-B data broadcast by the aircraft.

18. A computer-readable storage medium having instructions stored thereon that, when executed, cause one or more processors to:
receive a request to authenticate automatic dependent surveillance-broadcast (ADS-B) data;
generate a random value;
encrypt the random value with a public key of an aircraft to produce an encrypted random value;
send a challenge message to the aircraft with the encrypted random value;
receive a decrypted random value in response to the challenge message;
perform a comparison of the decrypted random value to the random value;
in response to the comparison indicating a challenge match, determine the ADS-B data as being sent by an authenticated sender;
in response to the comparison indicating a challenge mismatch, determine the ADS-B data as being sent by an unauthenticated sender; and
returning an indication of authenticated or unauthenticated in response to the request to authenticate based on determining the ADS-B data as being sent by an authenticated sender or an unauthenticated sender.

19. The computer-readable storage medium of claim 18, wherein the instructions further cause the one or more processors to:
receive a digital certificate from the aircraft with the decrypted random value;
perform an evaluation of the digital certificate against a tail number, wherein the request to authenticate the ADS-B data includes the tail number associated with the aircraft;
in response to the evaluation indicating a certificate match and the comparison indicating a challenge match, determine the ADS-B data as being sent by an authenticated sender; and
in response to the evaluation indicating a certificate mismatch, determine the ADS-B data as being sent by an unauthenticated sender.

20. The computer-readable storage medium of claim 19, wherein the instructions further cause the one or more processors to:
perform a second evaluation of the ADS-B data against flight mission parameters of the aircraft;
in response to the second evaluation indicating a flight mission match, the evaluation of the digital certificate indicating a certificate match, and the comparison indicating a challenge match, determine the ADS-B data as being sent by an authenticated sender; and
in response to the second evaluation indicating a flight mission mismatch, determine the ADS-B data as being sent by an unauthenticated sender.
